(19) United States
(12) Patent Application Publication
(10) Pub. No.: US 2025/0226778 A1
(43) Pub. Date: Jul. 10, 2025

(54) SENSORED FIELD ORIENTED CONTROL IN A POWER TOOL

(71) Applicant: MILWAUKEE ELECTRIC TOOL CORPORATION, Brookfield, WI (US)

(72) Inventors: Yangpingqing Hu, West Allis, WI (US); Vladan Jevremovic, Issaquah, WA (US); Nandini Ganesan, Milwaukee, WI (US); Austin Gaspar, Maple Valley, WA (US); Shuvam Gupta, Wauwatosa, WI (US)

(21) Appl. No.: 19/009,113

(22) Filed: Jan. 3, 2025

Related U.S. Application Data
(60) Provisional application No. 63/555,185, filed on Feb. 19, 2024.
(60) Provisional application No. 63/617,819, filed on Jan. 5, 2024.

(51) Int. Cl. H02P 21/12; B25F 5/00; H02P 21/18

(52) U.S. Cl. CPC H02P 21/12; H02P 21/18; B25F 5/008

(57) ABSTRACT

Power tools described herein include a housing, a battery pack receptacle, a brushless motor, one or more Hall effect sensors, a power switching circuit, a single current sensor, and an electronic controller. The battery pack receptacle is configured to receive a battery pack. A motor shaft is arranged to produce a rotational output to a drive mechanism. The one or more Hall effect sensors are configured to generate output signals corresponding to a rotational position of the brushless motor. The power switching circuit is configured to provide a supply of power from the battery pack to the brushless motor. The single current sensor is disposed between the battery pack and the brushless motor. The single current sensor is configured to measure the supply of power from the battery pack to the brushless motor. The electronic controller is configured to implement field-oriented control (“FOC”) of the brushless motor.

### RELATED APPLICATIONS

This application claims the benefit of U.S. Provisional Patent Application No. 63/617,819, filed Jan. 5, 2024, and U.S. Provisional Patent Application No. 63/555,185, filed Feb. 19, 2024, the entire content of each of which is hereby incorporated by reference.

### FIELD

Embodiments described herein relate to power tools including brushless direct current motors.

### SUMMARY

Conventional brushless direct current (“DC”) motors include a stator and a rotor configured to rotate with respect to the stator by a magnetic field generated in one or more phases of the stator. Typically, the stator and rotor are separated by an air-gap. In order to properly generate the magnetic field in the correct phase(s), conventional brushless DC motors further include a plurality of sensors, such as Hall effect sensors, configured to sense an angular position of the rotor with respect to the stator. In order to properly generate the magnetic field in the correct phase(s), one or more control algorithms are used to control the energization of the phases of the stator.

Embodiments described herein relate to a power tool that is configured to implement sensored field-oriented control (“sFOC”). In sFOC, both the stator and the rotor produce flux. In particular, the stator flux current, i_{d}, and the stator torque current, i_{q}, are two component currents making up the stator current vector, Iₛ. Therefore, stator flux can be determined as a function of stator current. The goal of sFOC is to align the stator flux to be orthogonal to the rotor flux. Once the position of the rotor is known, the power tool controls the phases of the stator to produce the proper magnetic field such that the stator flux remains orthogonal to the rotor flux. Controlling a motor via sFOC provides various benefits, such as independent control of motor speed and motor torque.

Unlike conventional motor control topologies (e.g., trapezoidal motor control, three-phase FOC, etc.), sFOC eliminates the need for shunts on the voltage source inverter (“VSI”) low-side legs or phases. Instead, the sFOC places one shunt on the VSI bus and samples when the inverter bus current is equal to the phase current. The information of the three-phase currents can then be reconstructed based on the measurements and completes the FOC current loop.

Also, unlike FOC that implements shunt resistors on VSI phases or legs, sFOC does not require an additional current sensing component on the bus for over-current protection (“OCP”).

Also, unlike classic block commutation control topologies often used in power tools and outdoor power equipment, sFOC exhibits better dynamic and steady-state performance and controllability.

Power tools described herein include a housing, a battery pack receptacle, a brushless motor, one or more Hall effect sensors, a power switching circuit, a single current sensor, and an electronic controller. The battery pack receptacle is disposed on the housing, and the battery pack receptacle is configured to receive a battery pack. The brushless motor is disposed in the housing. The brushless motor includes a rotor and a stator. The rotor is coupled to a motor shaft that is arranged to rotate about a longitudinal axis. The longitudinal axis extends through the motor shaft. The motor shaft is arranged to produce a rotational output to a drive mechanism. The one or more Hall effect sensors are disposed adjacent to the brushless motor. The one or more Hall effect sensors are configured to generate output signals corresponding to a rotational position of the brushless motor. The power switching circuit is configured to provide a supply of power from the battery pack to the brushless motor. The single current sensor is disposed between the battery pack and the brushless motor. The single current sensor is configured to measure the supply of power from the battery pack to the brushless motor. The electronic controller is connected to the one or more Hall effect sensors and the power switching circuit. The electronic controller is configured to implement field-oriented control (“FOC”) of the brushless motor.

In some aspects, the power tool further includes a mixed-signal programmable logic device electrically connected to the single current sensor, the mixed-signal programmable logic device configured to detect a fault condition.

In some aspects, the fault condition is a short-circuit condition.

In some aspects, the electronic controller is further configured to generate, with a speed regulator and the output signals from the one or more position sensors, a current command.

In some aspects, the electronic controller is further configured to determine a rotor speed based on the output signals from the one or more position sensors, and generate a current command using a speed regulator, the current command based on the rotor speed and a target speed.

In some aspects, the electronic controller is further configured to determine, based on a user selection, to operate in a torque mode, receive a torque input command based on a user input, and generate a current command based on the torque input command.

In some aspects, the electronic controller is further configured to determine a first feed forward term and a second feed forward term based on a signal from the single current sensor and the output signals from the one or more position sensors, wherein the first feed forward term corresponds to a motor speed and the second feed forward term corresponds to a motor torque.

In some aspects, the controller is further configured to, during a position control portion, receive the output signals from the one or more position sensors, determine a parameter of the brushless motor based on the output signals from the one or more position sensors, and, during a multi-sampling portion determine drive parameters of the motor based on the parameter of the brushless motor using FOC, generate drive commands based on the drive parameters, and drive the brushless motor based on the drive commands.

In some aspects, the position control portion operates at a first frequency and the multi-sampling portion operates at a second frequency greater than the first frequency.

In some aspects, the first frequency is a PWM frequency corresponding with the frequency used to control the rotation of the motor, and the second frequency is a multiple of the first frequency.

In some aspects, the electronic controller is further configured to, during a position control portion, determine a rotor speed based on the output signals from the one or more position sensors, and, during an external input portion, generate a current command using a speed regulator, the current command based on the rotor speed and a target speed.

In some aspects, the position control portion operates at a first frequency and the external input portion operates at a second frequency lower than the first frequency.

Methods described herein for controlling a brushless motor of a handheld power tool including, during an external input portion, generating, with a speed regulator and output signals received from a one or more position sensors, a current command, during a position control portion, determining a first feed forward term and a second feed forward term based on a signal from the current command and the output signals from the one or more position sensors, and determining a parameter of the brushless motor based on the first feed forward term and the second feed forward term; and during a multi-sampling portion, determining drive parameters of the motor based on the parameter of the brushless motor using FOC, generating drive commands based on the drive parameters, and driving the brushless motor based on the drive commands.

In some aspects, the first feed forward term corresponds to a motor speed and the second feed forward term corresponds to a motor torque.

In some aspects, the parameter of the brushless motor includes at least one of a rotational position, a speed, or an acceleration of the brushless motor.

In some aspects, the parameter of the brushless motor is a plurality of duty cycles for each phase of the motor.

Power tools described herein include a housing, a battery pack receptacle, a brushless motor, one or more position sensors, a single current sensor, and an electronic controller. The battery pack receptacle is disposed on the housing and configured to receive a battery pack. The brushless motor is disposed in the housing and includes a rotor and a stator. The rotor is coupled to a motor shaft arranged to rotate about a longitudinal axis extending through the motor shaft, and the motor shaft is arranged to produce a rotational output to a drive mechanism. The one or more position sensors are disposed adjacent to the brushless motor and configured to generate output signals corresponding to a rotational position of the brushless motor. The power switching circuit is configured to provide a supply of power from the battery pack to the brushless motor. The single current sensor is disposed between the battery pack and the brushless motor and configured to measure the supply of power from the battery pack to the brushless motor. The electronic controller is configured to implement field-oriented control (“FOC”) of the brushless motor. The electronic controller configured to during an external input portion, generate, with a speed regulator and output signals received from a one or more position sensors, a current command; during a position control portion, determine a first feed forward term and a second feed forward term based on a signal from the current command and the output signals from the one or more position sensors, and determine a parameter of the brushless motor based on the first feed forward term and the second feed forward term, and during a multi-sampling portion, determine drive parameters of the motor based on the parameter of the brushless motor using FOC, generate drive commands based on the drive parameters, and drive the brushless motor based on the drive commands.

In some aspects, the position control portion operates at a first frequency and the multi-sampling portion operates at a second frequency greater than the first frequency.

In some aspects, the first frequency is a PWM frequency corresponding with the frequency used to control the rotation of the motor and the second frequency is a multiple of the first frequency.

In some aspects, the external input portion operates at a third frequency lower than the first frequency.

Unless the context of their usage unambiguously indicates otherwise, the articles “a,” “an,” and “the” should not be interpreted as meaning “one” or “only one.” Rather, these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1 illustrates a power tool implementing sensored field oriented control, according to some embodiments.

FIG. 2 illustrates a cross-sectional view of a power tool implementing sensored field oriented control, according to some embodiments.

FIG. 3 illustrates a control system for a power tool implementing sensored field oriented control, according to some embodiments.

FIG. 4 is a block diagram for a control system of a power tool implementing sensored field oriented control, according to some embodiments.

FIG. 5 is a block diagram of a control topology for a power tool implementing sensored field oriented control, according to some embodiments.

FIG. 6 illustrates a motor timing diagram for a power tool implementing sensored field oriented control, according to some embodiments.

### DETAILED DESCRIPTION

Embodiments described herein relate to power tools, such as handheld power tools, that implement a sensored brushless direct-current motor (“sensored motor”) and sensored field-oriented control (“sFOC”).

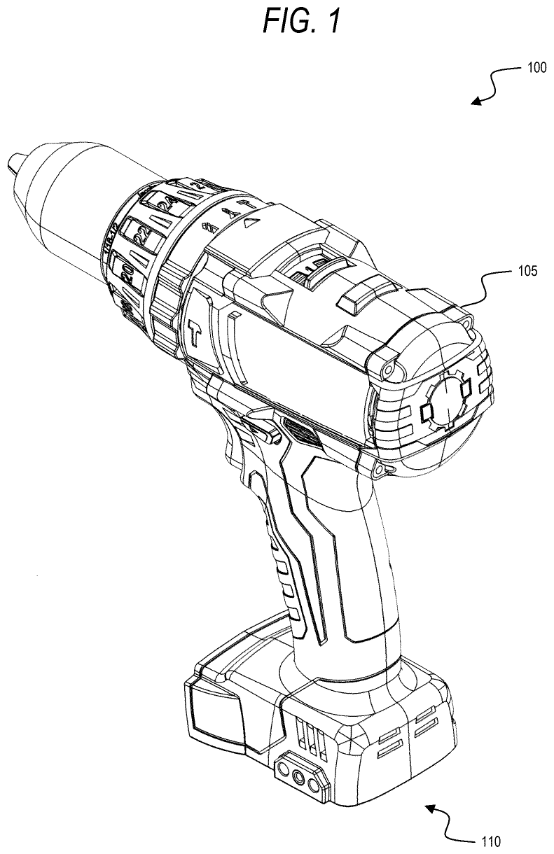

FIG. 1 illustrates a power tool 100 that implements sFOC. In the embodiment illustrated in FIG. 1, the power tool 100 is a drill/driver. In other embodiments, the power tool 100 is a different type of power tool (e.g., an impact wrench, a ratchet, a saw, a hammer drill, an impact driver, a rotary hammer, a grinder, a blower, a trimmer, a chainsaw, etc.). The power tool 100 includes a housing 105 and a battery pack interface 110, or receptacle, for connecting the power tool 100 to, for example, a battery pack. In some embodiments, the battery pack interface 110 may be configured to connect the power tool 100 to another device.

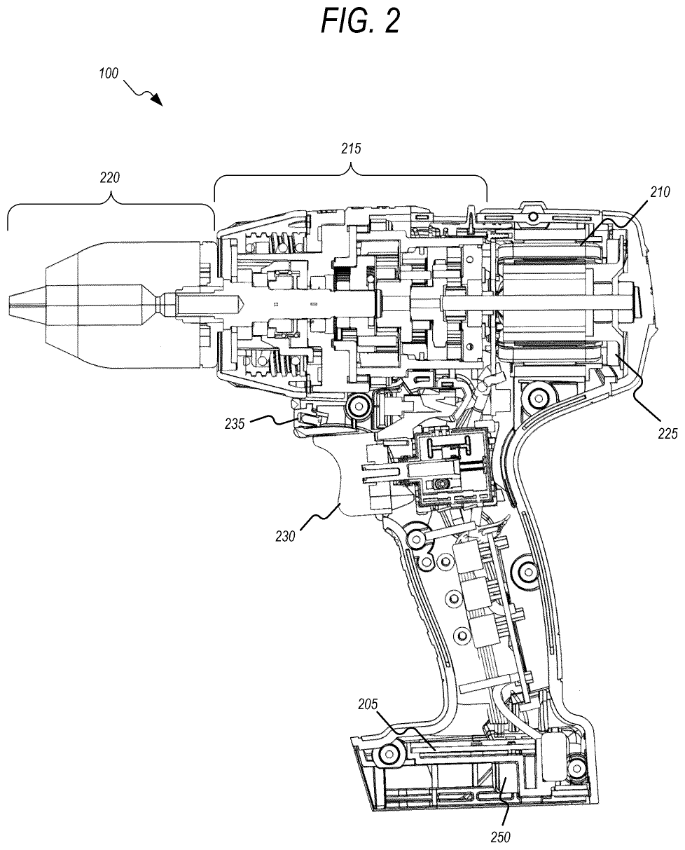

FIG. 2 illustrates a cross section of the power tool 100 of FIG. 1. The power tool 100 includes at least one printed circuit board (“PCB”) 205 for various components of the power tool 100. In some embodiments, the PCB 205 is a control PCB. In addition to or instead of the control PCB, the power tool 100 may include a power PCB, a forward/reverse PCB, and/or a light-emitting diode (“LED”) PCB. The power tool 100 may further include a motor 210. In some embodiments, the motor 210 may be a sensored motor. Also illustrated in FIG. 2 is a drive mechanism 215 for transmitting the rotational output of the motor 210 to an output unit 220, and a cooling fan 225 rotated by the motor 210 and used to provide a cooling air flow over components of the power tool 100. The power tool 100 may further include a trigger 230 configured to be actuated by a user. In some embodiments, an amount of actuation of the trigger 230 may be used to determine an amount of power supplied to the motor 210. The power tool 100 may further include a work light 235 configured to illuminate a working area of the power tool 100. In some embodiments, the work light 235 may be mounted below the drive mechanism 215. In some embodiments, the work light 235 may be configured to be activated in response to an actuation of the trigger 230.

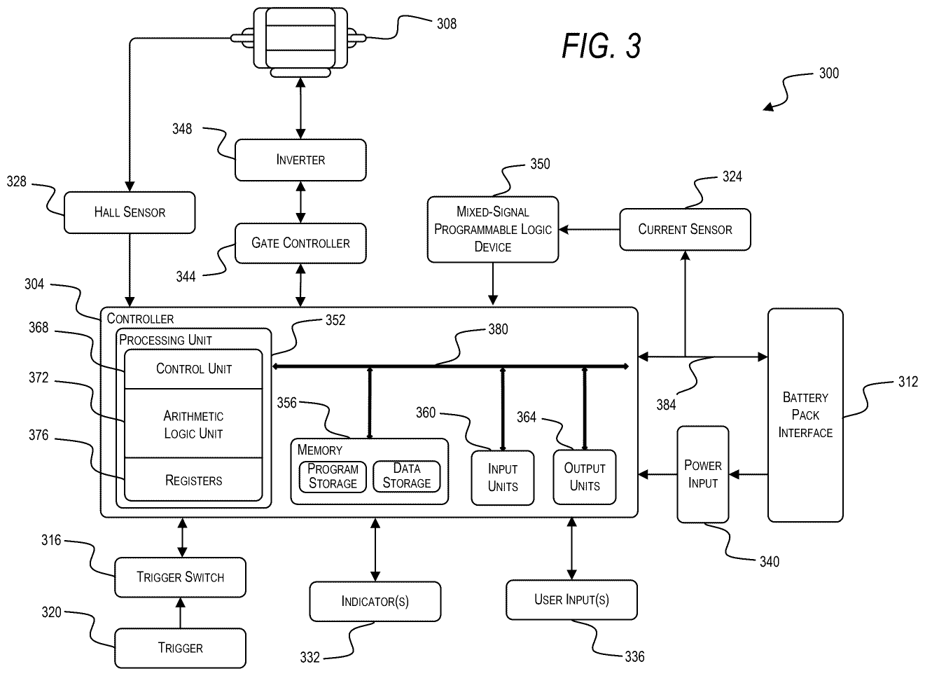

FIG. 3 illustrates a control system 300 for a power tool implementing sensored field oriented control (for example, the power tool 100 of FIG. 1). The control system 300 includes a controller 304. The controller 304 is electrically and/or communicatively connected to a variety of modules or components of the power tool. For example, the illustrated controller 304 is electrically connected to a motor 308 (for example, the motor 210 of FIG. 2), a battery pack interface 312 (for example, the battery pack interface 110 of FIG. 1), a trigger switch 316 (connected to a trigger 320, for example, the trigger 230 of FIG. 2), one or more sensors including at least a current sensor 324, a Hall effect sensor or sensors 328, a temperature sensor, one or more indicators 332, one or more user input modules 336, a power input module 340, a gate controller 344 (connected to an inverter 348), and a mixed-signal programmable logic device (“MS-PLD”) 350. The motor 308 includes a rotor, a stator, and a shaft that rotates about a longitudinal axis of the shaft. In some embodiments, the motor 308 is a three-phase permanent magnet synchronous motor (“PMSM”) or a brushless DC (“BLDC”) motor that employs Hall effect position sensors (“HPS”). In other embodiments, the motor 308 may implement other position sensor including magnetic sensors, inductive sensors, magnetic or inductive sine/cosine encoders, etc.

The controller 304 includes combinations of hardware and software that are operable to, among other things, control the operation of the power tool, monitor the operation of the power tool, activate the one or more indicators 332 (e.g., an LED), etc. The gate controller 344 is configured to control the inverter 348 to convert a DC power supply to a three-phase signal for powering the phases of the motor 308. The current sensor 324 is configured to, for example, sense a current drawn from the battery pack interface 312. The temperature sensor is configured to, for example, sense a temperature of the inverter 348. The MS-PLD 350 is configured to, for example, detect a short-circuit or line overcurrent event. In some embodiments, voltage signals that are proportional to the line currents (iₐ and i_{c}) and DC bus current (I_{dc}) are compared to predefined thresholds inside the MS-PLD 350 to detect the short-circuit or line overcurrent events.

The controller 304 includes a plurality of electrical and electronic components that provide power, operational control, and protection to the components and modules within the controller 304 and/or the power tool 100. For example, the controller 304 includes, among other things, a processing unit 352 (e.g., a microprocessor, a microcontroller, an electronic processor, an electronic controller, or another suitable programmable device), a memory 356, input units 360, and output units 364. The processing unit 352 includes, among other things, a control unit 368, an arithmetic logic unit (“ALU”) 372, and a plurality of registers 376 (shown as a group of registers in FIG. 3) and is implemented using a known computer architecture (e.g., a modified Harvard architecture, a von Neumann architecture, etc.). The processing unit 352, the memory 356, the input units 360, and the output units 364, as well as the various modules or circuits connected to the controller 304 are connected by one or more control and/or data buses (e.g., common bus 380). The control and/or data buses are shown generally in FIG. 3 for illustrative purposes. The use of one or more control and/or data buses for the interconnection between and communication among the various modules, circuits, and components would be known to a person skilled in the art in view of the invention described herein.

The memory 356 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 352 is connected to the memory 356 and executes software instructions that are capable of being stored in a RAM of the memory 356 (e.g., during execution), a ROM of the memory 356 (e.g., on a generally permanent basis), or another non-transitory computer readable medium such as another memory or a disc. Software included in the implementation of the power tool can be stored in the memory 356 of the controller 304. The software includes, for example, firmware, one or more applications, program data, filters, rules, one or more program modules, and other executable instructions. The controller 304 is configured to retrieve from the memory 356 and execute, among other things, instructions related to the control processes and methods described herein. In other constructions, the controller 304 includes additional, fewer, or different components.

The battery pack interface 312 includes a combination of mechanical components (e.g., rails, grooves, latches, etc.) and electrical components (e.g., one or more terminals) configured to and operable for interfacing (e.g., mechanically, electrically, and communicatively connecting) the power tool 100 with a battery pack. For example, power provided by the battery pack to the power tool is provided through the battery pack interface 312 to the power input module 340. The power input module 340 includes combinations of active and passive components to regulate or control the power received from the battery pack prior to power being provided to the controller 304. One such component may include a resistive current sensing shunt configured to convert the output battery current into an analog voltage input into the MS-PLD 350 and the controller 304. The battery pack interface 312 also supplies power to the inverter 348 to be switched by the switching FETS (e.g., Qₐ₊, Qₐ₋, Q_{b+}, Q_{b-}, Q_{c+}, Q_{c-}) to selectively provide power to the motor 308.

The MS-PLD 350 receives signals corresponding to the inverter/motor line currents, and DC bus currents are compared to predefined thresholds inside the MS-PLD 350 to detect, for example, a short-circuit or line overcurrent event. Upon detecting a fault, the MS-PLD 350 signals a fault to the controller 304. The MS-PLD 350 can be either a simple or a complex mixed-signal PLD that is, for example, EPROM, EEPROM, or flash-based.

The indicators 332 include, for example, one or more light-emitting diodes (“LEDs”). The indicators 332 can be configured to display conditions of, or information associated with, the power tool. For example, the indicators 332 are configured to indicate measured electrical characteristics of the power tool, the status of the device, etc. The one or more user input modules 336 may be operably coupled to the controller 304 to, for example, select a forward mode of operation or a reverse mode of operation, a torque and/or speed setting for the power tool (e.g., using torque and/or speed switches), etc. In some embodiments, the one or more user input modules 336 may include a combination of digital and analog input or output devices required to achieve a desired level of operation for the power tool, such as one or more knobs, one or more dials, one or more switches, one or more buttons, etc. In some embodiments, the one or more user input modules 336 may receive signals wirelessly from a device external to the power tool (e.g., a user's mobile phone).

The controller 304 may be configured to determine whether a fault condition of the power tool is present and generate one or more control signals related to the fault condition. For example, the controller 304 may calculate or include, within memory 356, predetermined operational threshold values and limits for operation of the power tool. For example, when a potential thermal failure (e.g., of a FET, the motor 308, etc.) or an abnormal battery voltage is detected or predicted by the controller 304 or MS-PLD 350, power to the motor 308 can be limited or interrupted until the potential for thermal failure is reduced. If the controller 304 detects one or more such fault conditions of the power tool or determines that a fault condition of the power tool no longer exists, the controller 304 may be configured to provide information and/or control signals to another component of the power tool (e.g., the battery pack interface 312, the indicators 332, etc.). The signals can be configured to, for example, trip or open a fuse of the power tool, reset a switch, etc.

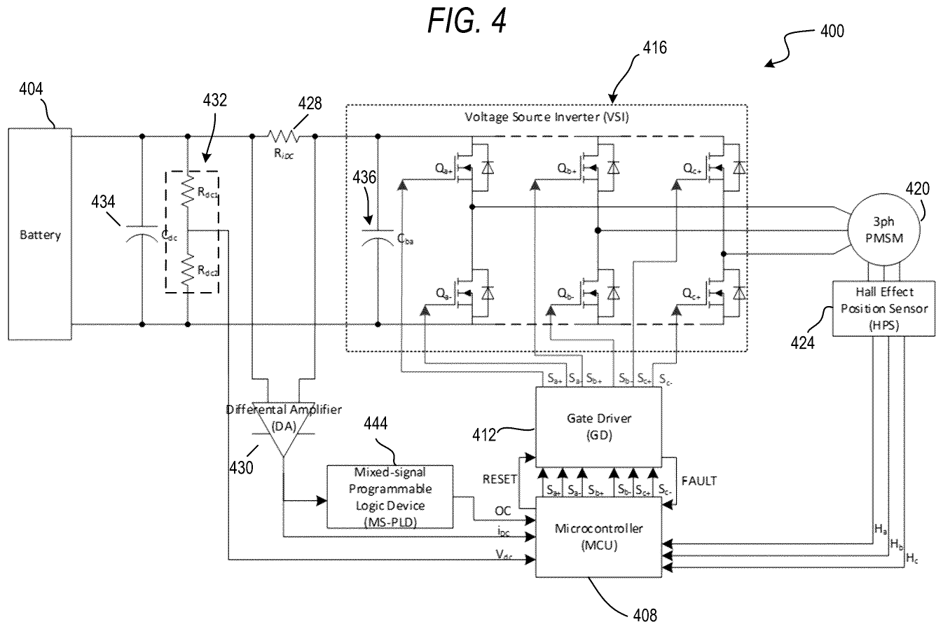

FIG. 4 illustrates a block diagram of an sFOC hardware topology 400 for a power tool (e.g., power tool 100). The sFOC hardware topology 400 is an exemplary implementation of the control system 300 disclosed in FIG. 3, and the incorporation of additional filters or specific implementations of any sensor, electrical component, controller, or power electronics as further disclosed does not preclude other implementations of the control system 300 and the electrical components disclosed therein.

The sFOC hardware topology 400 is a single-shunt-based FOC motor controller and is specifically designed as a motor controller for battery pack operated power tools and outdoor power equipment. The hardware topology 400 includes a battery pack or battery 404 which powers a microcontroller 408 (e.g., controller 304) and a motor 420 (e.g., motor 308). The microcontroller 408 is configured to communicate with a gate driver 412 to control a power switching circuit 416 (e.g., inverter 348) to drive the motor 420. As the motor 420 rotates, a Hall effect sensor 424 communicates with the microcontroller 408 such that the microcontroller 408 can determine a rotational position of the motor 420. In some embodiments, a plurality of Hall effect sensors 424 (e.g., three Hall effect sensors) are implemented.

The sFOC hardware topology 400 may also include a plurality of electrical and/or electronic components for the sensing, filtering, and processing of electrical signals. For example, the hardware topology 400 includes a battery current sensor 428 (e.g., a resistive current sensing shunt), a differential amplifier 430, a resistive voltage divider 432, a DC bus filter 434, a bridge capacitor 436, and a mixed-signal programmable logic device (“MS-PLD”) 444 (e.g., MS-PLD 350). Starting from the battery 404, the DC bus filter 434 is connected in parallel with the battery output and is configured to minimize voltage ripple and power dissipation across the DC bus due to the thermal stress on the DC bus. Therefore, the DC bus filter 434 is configured to improve the operational life of the power tool. The DC bus filter 434 includes one or more of solid polymer aluminum electrolytic capacitors, solid hybrid aluminum electrolytic capacitors connected, non-solid (wet) aluminum electrolytic capacitors, etc., connected in parallel. The capacitors are selected according to their size, voltage rating, ripple current rating, and equivalent series resistance (ESR) to minimize voltage ripple and power dissipation across the DC bus and provide sufficient operating life given the thermal stress.

The battery current sensor 428 is placed between the DC bus filter 434 and the power switching circuit 416, and is configured to convert an output battery current from the battery 404 into an analog voltage signal for the MS-PLD 444. The voltage on the shunt resistor is proportional to the current through the shunt resistor. Taking this voltage, the differential amplifier 430 yields an analog signal (i_{DC}) representing the sensed bus current. The current signal is subsequently directed to both the MS-PLD 444 and the microcontroller 408. The MS-PLD 444 also compares the current signal with a predefined threshold within the MS-PLD 444. In some embodiments, if the current signal produced by the differential amplifier 430 is greater than or equal to the predefined threshold, the MS-PLD 444 may determine that a short-circuit or line overcurrent (“OC”) event has occurred and communicate the error to the microcontroller 408.

Power from the DC bus is also provided to the power switching circuit 416, which includes three (3) half-bridges with six (6) power switches in total. In some embodiments, the power switches are field-effect transistors (“FETs”), metal-oxide semiconductor FETs (“MOSFETs”), etc. The power switching circuit 416 is configured to convert a DC voltage from the battery 404 to a three-phase voltage of variable amplitude and frequency to drive the motor 420. Each half-bridge includes two power switches (e.g., MOSFETs with anti-parallel [trench or body] diodes), with both power switches within a half-bridge connected in series and corresponding with a particular phase of the motor 420. In some embodiments, if a power switch current rating is below a required application rating, half-bridges can be paralleled (e.g., six in an inverter, with 2 per phase), resulting in a twelve-switch inverter. In some embodiments, the power switches can be silicon, silicon-carbide (“SiC”), or gallium-nitride (“GaN”) based power switches. A bridge capacitor 436 is placed in parallel with the half-bridges of the power switching circuit 416. The bridge capacitor 436 helps to improve the uniformity of the impedances of each phase of the motor 420. In some embodiments, the bridge capacitor 436 may be a plurality of bridge capacitors that are each placed in parallel with a corresponding half bridge of the power switching circuit 416 (e.g., a corresponding phase). In such an embodiment, the capacitance of each capacitor of the plurality of bridge capacitors may be lowered to allow the current transients to pass through and be measured by the battery current sensor 428.

The microcontroller 408 receives signals from the various sensors in order to, among other things, control the operation of the power tool, monitor the power tool, and activate one or more indicators 332 (e.g., an LED) based on the status of the power tool. For example, a voltage across the DC bus (V_{dc}) is divided with the resistive voltage divider 432. The attenuated signal is connected to one of the inputs of the microcontroller 408′s analog-to-digital converter (“ADC”). The microcontroller 408 is configured to compare the signal from the voltage divider 432 to a predefined threshold value stored in the microcontroller 408 to provide overvoltage and undervoltage protection (e.g., monitoring a voltage of the battery 404). The microcontroller 408 is also configured to account for the signal from the voltage divider 432 when controlling the motor 420 to minimize the effect of the voltage ripple across the DC bus, and for determining a current trajectory in the case of an MTPV implementation. The microcontroller 408 may also incorporate the signals produced by the Hall effect sensors 424 to control the driving of the motor 420. Specifically, the Hall effect sensors 424 are used by the microcontroller 408 to estimate the position and speed of the motor 420. Using the signals from the voltage divider 432, current sensor 428, and the Hall effect sensors 424, the microcontroller 408 is configured to implement a closed-loop sensored field-oriented control (sFOC) algorithm. For example, the microcontroller 408 may use the DC bus current measured by the battery current sensor 428 and determine the feedback phase currents for field-oriented control. The microcontroller 408 may then generate switching signals (Sₐ₊, Sₐ₋, S_{b+}, S_{b-}, S_{c+}, and S_{c-}) for each half-bridge MOSFET. The switching signals are provided to the gate driver 412 and used to drive the motor 420 at a specific speed and/or torque.

Notably, unlike conventional three-phase current FOC where both the battery current and the current at each phase of the motor 420 is monitored, the topology 400 illustrated in FIG. 4 only uses one (a single) shunt resistor and current sense amplifier. Accordingly, in addition to reducing the required amount of hardware, the control and benefits of FOC remain with qualitative improvements. Specifically, the topology 400 allows for a more compact power switching circuit 416 and a more consistent impedance, and therefore a more consistent phase reading between each phase of the motor 420.

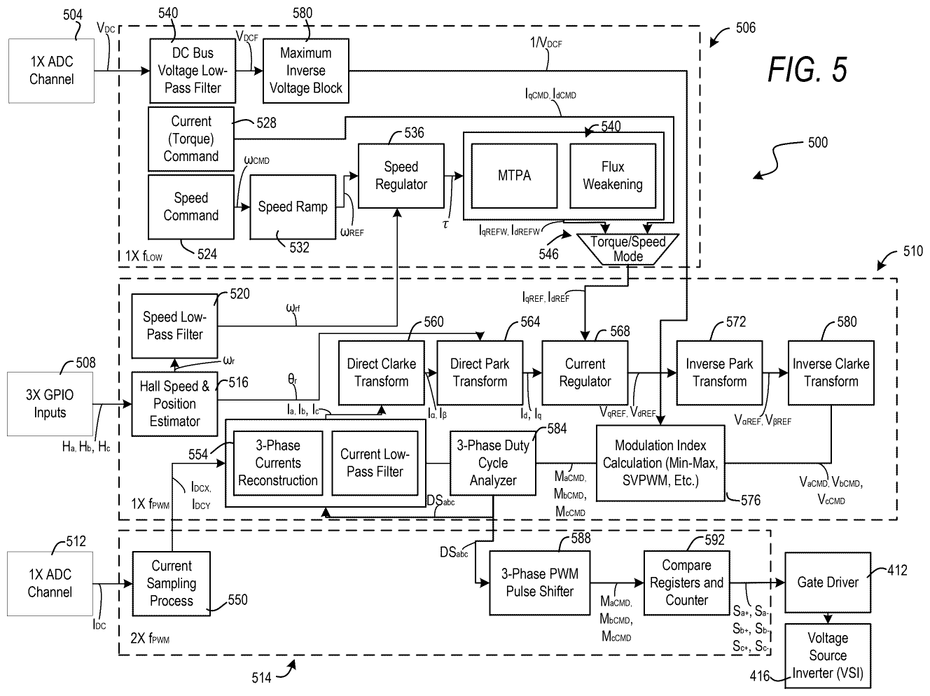

FIG. 5 illustrates a block diagram of a single-shunt-based FOC motor control system 500 of a sensored field-oriented control (“sFOC”) algorithm implemented by a power tool (e.g., power tool 100). The control system 500 can be implemented by a controller (e.g., controller 304, microcontroller 408, etc.) of a power tool, and may include one or more additional controllers (e.g., dedicated controllers). The control system 500 also includes one or more sensors and components for receiving signals from the sensors. For example, as illustrated in FIG. 5, the control system 500 includes a battery voltage input block 504, a Hall effect sensor input block 508, and a current input block 512 (e.g., from battery current sensor 428). Additionally, in the illustrated embodiment, the control system 500 operates different control portions at different frequencies including an external input portion 506, a position control portion 510, and a multi-sampling portion 514. For example, the position control portion 510 is connected to the Hall effect sensor input block 508 and operates over a period of the PWM commutation cycle. The external input portion 506 is configured to receive commands from a user and accordingly will operate at a much lower frequency. The multi-sampling portion 514 is configured to receive multiple signals over the course of the PWM commutation cycle in order to allow for dynamic measurement and control. In other words, the position control portion 510 may operate at a first frequency, the multi-sampling portion 514 may operate at a second frequency greater than the first frequency, and the external input portion 506 may operate at a third frequency lower than the first frequency and the second frequency. In one example, the position control portion 510 may operate at a frequency corresponding with the PWM frequency used to control the rotation of the motor (e.g., motor 420) and the multi-sampling portion 514 may operate at a frequency corresponding with a multiple (e.g., 2×, 3×, 4×, etc.) of the PWM frequency.

A period of the signals from the Hall effect sensors is measured at block 516 by measuring the time between rising and falling edges of three Hall effect sensors to determine the rotor speed (wᵣ). The rotor speed (wᵣ) is then filtered through a low-pass filter at block 520 to produce a filtered speed value (w_{rf}). The control system 500 may also receive one or more user inputs. For example, the control system 500 includes a speed command block 524 and a torque command block 528 configured to respectively generate a speed command (w_{cmd}) and directional torque commands (i_{dcmd} and i_{qcmd}) based on a position of a user input (e.g., trigger 230). The control system 500 further includes a speed ramp block 532 configured to determine a speed reference (ωrref) based on the speed command and a reference acceleration or deceleration rate. Additionally, the speed ramp block 532 determines an acceleration or deceleration torque (Tacc) that can be used by a speed regulator at block 536 to produce a speed control signal (i_{ref}). In other words, the speed regulator at block 536 is configured to receive a first signal (Φ_{rf}) corresponding to a present angular speed of the rotor of the motor (e.g., motor 420) and a second signal (ωrref) corresponding to a target angular speed for the rotor. The speed regulator at block 536 is then configured to generate a stator current signal (i_{ref}) to control the stator based on the present angular speed (ω_{rf}) in reference to the target angular speed (ωrref).

The control system 500 includes a flux weakening block 540 configured to implement a max-torque-per-amps (“MTPA”) algorithm and, in some embodiments, a max-torque-per-volts (“MTPV”) algorithm. The flux weakening block 540 is configured to determine reference direct and quadrature axis stator currents (i_{dref} and i_{gref}) while implementing the MTPA algorithm or the MTPV algorithm with or without flux-weakening action. The MTPA algorithm is configured to receive the stator current signal i_{ref} and generate a flux current signal i_{dref} and a torque current signal i_{qref}. In some embodiments, the MTPA algorithm is configured to determine if an MPTA vector (i.e., a resultant vector created by the component i_{d} and i_{q} vectors) is a minimum current space vector. Additionally, the MTPA algorithm may recalculate the MPTA vector if the MTPA vector is not a minimum current space vector or otherwise does not satisfy predetermined constraints.

The MTPV algorithm additionally receives both the filtered rotor speed (w_{rf}) and a DC bus voltage (V_{dcf}). In some embodiments, the DC bus voltage (V_{dcf}) is passed through a filter (e.g., a low-pass filter) before being input into the flux weakening block 540. The MTPV algorithm also receives, for example, a flux current signal i_{d}, and generates a torque current signal i_{q}. The MTPV algorithm determines a scaling factor based on an angle of the MTPA vector output by the MTPA algorithm. The scaling factor may be between 0 and 1. The algorithm also includes determining an MTPV vector as the product of the MTPA vector and the scaling factor. In some embodiments, the scaling factor is 1. In these embodiments, the MTPV vector is the same as the MTPA vector. The MTPV algorithm may also determine a negative current based on the MTPV vector. In some embodiments, the user may select an output mode of the power tool. Based on the user selection at block 546, the control system 500 may select a torque mode or a speed mode and accordingly adjust the reference currents used to control the motor.

The control system 500 includes a current sampling block 550 and a current reconstruction block 554. The current sampling block 550 is configured to arrange two samples of the bus current (i_{DC}) read from the ADC at block 512 into two bus components (i_{DC}^{x}, i_{DC}^{y}) equal to two leg currents of the power switching circuit 416. Then, at block 560, the control system 500 transforms the motor currents using a direct Clarke transform to decouple and reduce the symmetrical three-phase system into a two-phase system with only two currents (i_{α} and i_{β}). The control system 500 includes direct Park transform block 564 configured to receive the two- phase current signals (i_{α} and i_{β}) from the direct Clarke transform block 560 and a signal θₕₐₗₗ relating to present angular position of the rotor of the motor from a Hall effect sensors (e.g., Hall effect sensors 328). The direct Clarke transform block 560 is configured to transform a stationary reference frame into a synchronously rotating reference frame. The direct Park transform block 564 is further configured to generate a first current signal i_{q} corresponding to a total torque current of the motor and a second current signal i_{d} corresponding to a total flux current of the motor based on the two-phase current signal i_{α}, id_{β} and the signal θₕₐₗₗ.

The reference stator currents (i_{dref} and i_{gref}) from the flux weakening block 540 are fed into a current regulator block 568. The current regulator block 568 is configured to calculate feed forward terms for the current regulators (FF_{d} and FF_{q}) that reduce inherent cross-coupling between the direct and quadrature axes and enable independent regulation of both currents. Using the calculated feed-forward terms FF_{d} and FF_{q}, the current regulator block 568 adjusts the flux and torque current signals i_{d} and i_{q} determined in the direct Park transformation block 560 toward the respective reference currents i_{dref} and i_{gref}, thereby generating reference d-axis and q-axis voltages V_{dref} and V_{qref}. In other words, the control system 500 may be configured to adjust the injected stator flux current based on the feed forward terms.

The control system 500 further includes an inverse Park transform block 572 configured to receive a first signal V_{d} from the flux controller corresponding to a flux voltage, a second signal V_{q} from the torque controller corresponding to a torque voltage, and the signal θₕₐₗₗ corresponding to a present angular position of a rotor of the motor from the hall sensor. The inverse Park transform block 572 may be configured to convert the first signal V_{d} and second signal V_{q} to orthogonal stationary reference frame quantities V_{α} and V_{β} based on the signal θₕₐₗₗ. The inverse Park transform block 572 is then configured to output the orthogonal stationary reference frame quantities V_{α} and V_{β}, which are used to drive the motor 420.

The control system 500 includes a modulation index calculation block 576 configured to determine modulation indices on stationary reference frame axes (m_{α} and m_{β}), and a reference modulation index (m_{ref}) based on the inverse value of the maximum fundamental stator voltage (1/Vₘₐₓ) determined by the inverse Clarke transform block 580. In some embodiments, the scaling factor of the MTPV algorithm may be determined by the modulation index calculation block 576. In some embodiments, the modulation index may be adjustable according to other tool parameters (e.g., temperature, battery life, etc.).

The three-phase duty cycle analyzer block 584 determines a duty cycle status (DS_{abc}) based on comparing the determined motor phases with the modulation index. The duty cycle status (DS_{abc}) indicates which phase is to be modified in the PWM pulse shifter block. In some embodiments, DS_{abc} also guides the three-phase current reconstruction blocks.

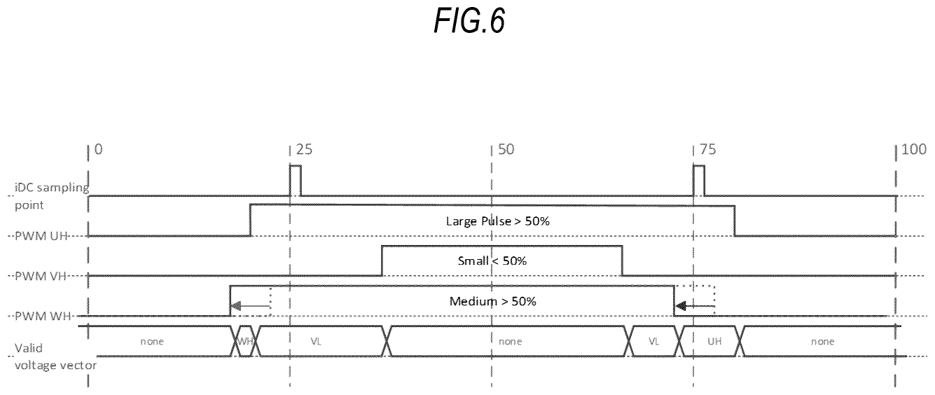

The control system 500 includes a three-phase PWM pulse shifter block 588 configured to calculate drive parameters or duty cycles (PWMₐ, PWMb, PWMc) for each phase of the motor based on the duty cycle status (DS_{abc}) through the implementation or blending of various PWM strategies (e.g., third harmonic injection, min-max, space-vector pulse width modulation, discontinuous pulse width modulation, etc.). In some embodiments, the PWM strategy or a combination of PWM strategies is determined by the reference modulation index (m_{ref}) and stator frequency. If, for example, the reference modulation index requires overmodulation (nonlinear mode) operation, the control system 500 is configured to perform linearization of the overall gain. This block executes twice in one PWM cycle to allow PWM double updates. Thus, two distinct values are applied to generate switching signals. As shown in FIG. 6, this shifting allows two valid voltage vectors to cover the duration during which the ADC samples the bus current.

Upon determining the duty cycles for each phase of the motor, the duty cycles are converted into register values at block 592 and compared to a continuous up-down counter. The control system 500 at block 592 is configured to use the compare register values and counter to generate the drive commands or switching signals (Sₐ₊, Sₐ₋, S_{b+}, S_{b-}, S_{c+}, and S_{c-}) used to control a gate driver (e.g., gate driver 412), which then drives a power switching circuit 416 to drive the motor 420.

### Representative Features

Representative features are set out in the following clauses, which stand alone or may be combined, in any combination, with one or more features disclosed in the text and/or drawings of the specification.

Clause 1. A power tool comprising: a housing; a battery pack receptacle disposed on the housing, the battery pack receptacle configured to receive a battery pack; a brushless motor disposed in the housing, the brushless motor including a rotor and a stator, the rotor is coupled to a motor shaft arranged to rotate about a longitudinal axis, the longitudinal axis extending through the motor shaft, the motor shaft arranged to produce a rotational output to a drive mechanism; one or more position sensors disposed adjacent to the brushless motor, the one or more position sensors configured to generate output signals corresponding to a rotational position of the brushless motor; a power switching circuit configured to provide a supply of power from the battery pack to the brushless motor; a single current sensor disposed between the battery pack and the brushless motor, the current sensor configured to measure the supply of power from the battery pack to the brushless motor; and an electronic controller connected to the one or more position sensors, the single current sensor, and the power switching circuit, the electronic controller configured to implement field-oriented control (“FOC”) of the brushless motor.

Clause 2. The power tool of clause 1 further comprising: a mixed-signal programmable logic device electrically connected to the single current sensor, the mixed-signal programmable logic device configured to detect a fault condition.

Clause 3. The power tool of clause 2, wherein the fault condition is a short-circuit condition.

Clause 4. The power tool of any preceding clause, wherein the electronic controller is further configured to: generate, with a speed regulator and the output signals from the one or more position sensors, a current command.

Clause 5. The power tool of any preceding clause, wherein the electronic controller is further configured to: determine a rotor speed based on the output signals from the one or more position sensors; and generate a current command using a speed regulator, the current command based on the rotor speed and a target speed.

Clause 6. The power tool of clause 5, wherein the electronic controller is further configured to: determine, based on a user selection, to operate in a torque mode; receive a torque input command based on a user input; and generate a current command based on the torque input command.

Clause 7. The power tool of any preceding clause, wherein the electronic controller is further configured to: determine a first feed forward term and a second feed forward term based on a signal from the single current sensor and the output signals from the one or more position sensors, wherein the first feed forward term corresponds to a motor speed and the second feed forward term corresponds to a motor torque.

Clause 8. The power tool of any preceding clause, wherein the controller is further configured to: during a position control portion, receive the output signals from the one or more position sensors, determine a parameter of the brushless motor based on the output signals from the one or more position sensors; and during a multi-sampling portion, determine drive parameters of the motor based on the parameter of the brushless motor using FOC, generate drive commands based on the drive parameters, and drive the brushless motor based on the drive commands.

Clause 9. The power tool of clause 8, wherein the position control portion operates at a first frequency and the multi-sampling portion operates at a second frequency greater than the first frequency.

Clause 10. The power tool of clause 9, wherein the first frequency is a PWM frequency corresponding with the frequency used to control the rotation of the motor, and the second frequency is a multiple of the first frequency.

Clause 11. The power tool of any preceding clause, wherein the electronic controller is further configured to: during a position control portion, determine a rotor speed based on the output signals from the one or more position sensors; and during an external input portion, generate a current command using a speed regulator, the current command based on the rotor speed and a target speed.

Clause 12. The power tool of clause 11, wherein the position control portion operates at a first frequency and the external input portion operates at a second frequency lower than the first frequency.

Clause 13. A method of controlling a brushless motor of a handheld power tool, the method comprising: during an external input portion, generating, with a speed regulator and output signals received from a one or more position sensors, a current command; during a position control portion, determining a first feed forward term and a second feed forward term based on a signal from the current command and the output signals from the one or more position sensors, and determining a parameter of the brushless motor based on the first feed forward term and the second feed forward term; and during a multi-sampling portion, determining drive parameters of the motor based on the parameter of the brushless motor using field-oriented control (“FOC”), generating drive commands based on the drive parameters, and driving the brushless motor based on the drive commands.

Clause 14. The method of clause 13, wherein the first feed forward term corresponds to a motor speed and the second feed forward term corresponds to a motor torque.

Clause 15. The method of clause 13 or 14, wherein the parameter of the brushless motor includes at least one of a rotational position, a speed, or an acceleration of the brushless motor.

Clause 16. The method of clause 13, 14, or 15, wherein the parameter of the brushless motor is a plurality of duty cycles for each phase of the motor.

Clause 17. A power tool comprising: a housing; a battery pack receptacle disposed on the housing, the battery pack receptacle configured to receive a battery pack; a brushless motor disposed in the housing, the brushless motor including a rotor and a stator, the rotor is coupled to a motor shaft arranged to rotate about a longitudinal axis, the longitudinal axis extending through the motor shaft, the motor shaft arranged to produce a rotational output to a drive mechanism; one or more position sensors disposed adjacent to the brushless motor, the one or more position sensors configured to generate output signals corresponding to a rotational position of the brushless motor; a power switching circuit configured to provide a supply of power from the battery pack to the brushless motor; a single current sensor disposed between the battery pack and the brushless motor, the single current sensor configured to measure the supply of power from the battery pack to the brushless motor; and an electronic controller configured to implement field-oriented control (“FOC”) of the brushless motor, the electronic controller configured to: during an external input portion, generate, with a speed regulator and output signals received from a one or more position sensors, a current command; during a position control portion, determine a first feed forward term and a second feed forward term based on a signal from the current command and the output signals from the one or more position sensors, and determine a parameter of the brushless motor based on the first feed forward term and the second feed forward term; and during a multi-sampling portion, determine drive parameters of the motor based on the parameter of the brushless motor using FOC, generate drive commands based on the drive parameters, and drive the brushless motor based on the drive commands.

Clause 18. The power tool of clause 17, wherein the position control portion operates at a first frequency and the multi-sampling portion operates at a second frequency greater than the first frequency.

Clause 19. The power tool of clause 18, wherein the first frequency is a PWM frequency corresponding with the frequency used to control the rotation of the motor and the second frequency is a multiple of the first frequency.

Clause 20. The power tool of clause 18 or 19, wherein the external input portion operates at a third frequency lower than the first frequency.

Thus, embodiments described herein provide systems, devices, for implementing sensored field-oriented control on a power tool including a brushless DC motor. Various features and advantages are set forth in the following claims.

What is claimed is:

1. A power tool comprising:
a housing;
a battery pack receptacle disposed on the housing, the battery pack receptacle configured to receive a battery pack;
a brushless motor disposed in the housing, the brushless motor including a rotor and a stator, the rotor is coupled to a motor shaft arranged to rotate about a longitudinal axis, the longitudinal axis extending through the motor shaft, the motor shaft arranged to produce a rotational output to a drive mechanism;
one or more position sensors disposed adjacent to the brushless motor, the one or more position sensors configured to generate output signals corresponding to a rotational position of the brushless motor;
a power switching circuit configured to provide a supply of power from the battery pack to the brushless motor;
a single current sensor disposed between the battery pack and the brushless motor, the current sensor configured to measure the supply of power from the battery pack to the brushless motor; and
an electronic controller connected to the one or more position sensors, the single current sensor, and the power switching circuit, the electronic controller configured to implement field-oriented control (“FOC”) of the brushless motor.

2. The power tool of claim 1 further comprising:
a mixed-signal programmable logic device electrically connected to the single current sensor, the mixed-signal programmable logic device configured to detect a fault condition.

3. The power tool of claim 2, wherein the fault condition is a short-circuit condition.

4. The power tool of claim 1, wherein the electronic controller is further configured to:
generate, with a speed regulator and the output signals from the one or more position sensors, a current command.

5. The power tool of claim 1, wherein the electronic controller is further configured to:
determine a rotor speed based on the output signals from the one or more position sensors; and
generate a current command using a speed regulator, the current command based on the rotor speed and a target speed.

6. The power tool of claim 5, wherein the electronic controller is further configured to:
determine, based on a user selection, to operate in a torque mode;
receive a torque input command based on a user input; and
generate a current command based on the torque input command.

7. The power tool of claim 1, wherein the electronic controller is further configured to:
determine a first feed forward term and a second feed forward term based on a signal from the single current sensor and the output signals from the one or more position sensors,
wherein the first feed forward term corresponds to a motor speed and the second feed forward term corresponds to a motor torque.

8. The power tool of claim 1, wherein the electronic controller is further configured to:
during a position control portion,
receive the output signals from the one or more position sensors, and
determine a parameter of the brushless motor based on the output signals from the one or more position sensors; and
during a multi-sampling portion,
determine drive parameters of the motor based on the parameter of the brushless motor using FOC,
generate drive commands based on the drive parameters, and
drive the brushless motor based on the drive commands.

9. The power tool of claim 8, wherein the position control portion operates at a first frequency and the multi-sampling portion operates at a second frequency greater than the first frequency.

10. The power tool of claim 9, wherein the first frequency is a PWM frequency corresponding with the frequency used to control the rotation of the motor, and the second frequency is a multiple of the first frequency.

11. The power tool of claim 1, wherein the electronic controller is further configured to:
during a position control portion, determine a rotor speed based on the output signals from the one or more position sensors; and
during an external input portion, generate a current command using a speed regulator, the current command based on the rotor speed and a target speed.

12. The power tool of claim 11, wherein the position control portion operates at a first frequency and the external input portion operates at a second frequency lower than the first frequency.

13. A method of controlling a brushless motor of a handheld power tool, the method comprising:
during an external input portion,
generating, with a speed regulator and output signals received from a one or more position sensors, a current command;
during a position control portion,
determining a first feed forward term and a second feed forward term based on a signal from the current command and the output signals from the one or more position sensors, and
determining a parameter of the brushless motor based on the first feed forward term and the second feed forward term; and
during a multi-sampling portion,
determining drive parameters of the motor based on the parameter of the brushless motor using field-oriented control (“FOC”),
generating drive commands based on the drive parameters, and
driving the brushless motor based on the drive commands.

14. The method of claim 13, wherein the first feed forward term corresponds to a motor speed and the second feed forward term corresponds to a motor torque.

15. The method of claim 13, wherein the parameter of the brushless motor includes at least one of a rotational position, a speed, or an acceleration of the brushless motor.

16. The method of claim 13, wherein the parameter of the brushless motor is a plurality of duty cycles for each phase of the motor.

17. A power tool comprising:
a housing;
a battery pack receptacle disposed on the housing, the battery pack receptacle configured to receive a battery pack;
a brushless motor disposed in the housing, the brushless motor including a rotor and a stator, the rotor is coupled to a motor shaft arranged to rotate about a longitudinal axis, the longitudinal axis extending through the motor shaft, the motor shaft arranged to produce a rotational output to a drive mechanism;
one or more position sensors disposed adjacent to the brushless motor, the one or more position sensors configured to generate output signals corresponding to a rotational position of the brushless motor;
a power switching circuit configured to provide a supply of power from the battery pack to the brushless motor;
a single current sensor disposed between the battery pack and the brushless motor, the single current sensor configured to measure the supply of power from the battery pack to the brushless motor; and
an electronic controller configured to implement field-oriented control (“FOC”) of the brushless motor, the electronic controller configured to:
during an external input portion,
generate, with a speed regulator and output signals received from a one or more position sensors, a current command;
during a position control portion,
determine a first feed forward term and a second feed forward term based on a signal from the current command and the output signals from the one or more position sensors, and
determine a parameter of the brushless motor based on the first feed forward term and the second feed forward term; and
during a multi-sampling portion,
determine drive parameters of the motor based on the parameter of the brushless motor using FOC,
generate drive commands based on the drive parameters, and
drive the brushless motor based on the drive commands.

18. The power tool of claim 17, wherein the position control portion operates at a first frequency and the multi-sampling portion operates at a second frequency greater than the first frequency.

19. The power tool of claim 18, wherein the first frequency is a PWM frequency corresponding with the frequency used to control the rotation of the motor and the second frequency is a multiple of the first frequency.

20. The power tool of claim 18, wherein the external input portion operates at a third frequency lower than the first frequency.
